(19) United States
(12) Patent Application Publication
(10) Pub. No.: US 2002/0039675 A1
(43) Pub. Date: Apr. 4, 2002

(54) Compounding and molding process for fuel cell collector plates

(76) Inventors: James C. Braun, Juno Beach, FL (US); John E. Zabriskie JR., Port St. Lucie, FL (US); Jay K. Neutzler, Palm Beach Gardens, FL (US); Michel Fuchs, Boynton Beach, FL (US); Robert C. Gustafson, Palm Beach Gardens, FL (US); Blaine Priebe JR., Boynton Beach, FL (US)

Correspondence Address: AKERMAN, SENTERFITT & EIDSON, P.A., 222 Lakeview Avenue - 4th Floor, P. O. Box 3188, West Palm Beach, FL, 33402-3188, US

(21) Appl. No.: 09/859,730

(22) Filed: May 17, 2001

Related U.S. Application Data
(63) Continuation of application No. PCT/US99/27606, filed on Nov. 18, 1999.

(51) Int. Cl. H01M 8/02; H01M 8/10; B29C 43/02

(52) U.S. Cl. 429/34; 429/30; 264/528; 264/535

(57) ABSTRACT

An improved molding process provides highly conductive polymer composite parts have bulk conductivity over 10 S/cm. This conductivity is particularly useful in collector plate for use in fuel cells. The process can include compounding of a mixture of conductive filler with a polymer binder, extruding the mixture after the binder is plasticized to make pellets. The pellets can then be introduced to a dual temperature feed container of an injection molding machine and injected under high pressure and velocity into the mold cavity. The resulting parts, and particularly collector plates can be made economically and provide a high conductivity while maintaining strength and chemical resistance properties.

### CROSS-REFERENCE TO RELATED APPLICATION

This is a continuation-in-part application of International Application No. PCT/US99/27606, filed Nov. 18, 1999, designating the United States, and U.S. application Ser. No. 09/195,307, filed Nov. 18, 1998 which is now U.S. Pat. No. 6,180,275 B.

### FIELD OF THE INVENTION

This invention relates to compositions and methods for fabricating electrically-conductive polymer composite structures and coatings. More specifically, the invention relates to a highly-conductive graphite composite particularly suited for molding a current collector plate for a fuel cell.

### BACKGROUND OF THE INVENTION

Solid polymer electrolyte membrane (PEM) type electrochemical fuel cells are well known. Generally, PEM fuel cells comprise a membrane electrode assembly (MEA) and diffusion backing structure interposed between electrically conductive graphite current collector plates. In operation, multiple individual cells are arranged to form a fuel cell stack. When the individual cells are arranged in series to form a fuel cell stack, the current collector plates are referred to as bipolar collector plates. The collector plates perform multiple functions, including: (1) providing structural support; (2) providing electrical connection between cells; (3) directing fuel and oxidant reactants and/or coolant to individual cells; (4) distributing reactant streams and/or coolant within individual cells; (5) removing byproduct from individual cells; and (6) separating fuel and oxidant gas streams between electrically connected cells. In addition to being electrically conductive, collector plates must have good mechanical strength, high thermal stability, high resistance to degradation caused by chemical attack and/or hydrolysis, and low permeability to hydrogen gas.

Typically, collector plates have intricate patterns formed on their major surfaces. For instance, integral channels may be provided for directing fuel, oxidant and/or byproduct through the fuel cell. Historically, graphite structures have been machined to a desired configuration from graphite composite blanks. Due in part to the expense and time consuming nature of machining, more recent efforts in the fuel cell manufacturing industry have focused on the development of compositions and methods for producing net shape molded fuel cell structures, such as bipolar collector plates, using compression molding and injection molding techniques. These efforts, which have had limited success, have concentrated primarily on molding compositions incorporating fluoropolymer binder materials. For example, bipolar collector plates molded from thermoplastic fluoropolymers, such as vinylidene fluoride, are disclosed in U.S. Pat. Nos. 3,801,374, 4,214,969, and 4,988,583.

Compared to other polymeric materials, fluoropolymers have relatively high viscosities. Significantly, the relatively high viscosity associated with fluoropolymers limits their effectiveness as binder materials in molding and coating compositions.

In an effort to maximize the electrical conductivity of current collector plates for fuel cells, it is desirable to maximize electrically-conductive filler loading levels. Generally, as the percentage of filler particles in a given polymer composition is increased, there is a corresponding increase in the viscosity of the composition. Consequently, regardless of the polymer binder material chosen, the addition of electrically conductive filler must be limited to ensure some minimum degree of flow during processing. Such viscosity limitations are particularly pronounced in injection molding applications, where the viscosity of the polymer composition must be maintained at a low enough level to allow the composition to travel through intricate mold features such as channels and gates. In the case of fluoropolymer compositions, the high initial viscosity level associated with the fluoropolymer binder restricts the quantity of filler that can be loaded into the binder prior to processing. Consequently, the electrical conductivity of fuel cell collector plates fabricated using fluoropolymer binders is correspondingly limited.

For these and other reasons, there is a well-established need for improved compositions and methods for processing highly conductive composite structures for electronic, thermoelectric and electrochemical device applications.

### SUMMARY OF THE INVENTION

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, the preferred methods and materials are described below. All publications, patent applications, patents, and other references mentioned herein are incorporated by reference in their entirety. In case of conflict, the present specification, including definitions, will control. In addition, the materials, methods, and examples are illustrative only and not intended to be limiting.

It is an object of this invention to provide a composition for fabricating thermally- and electrically-conductive polymer composite structures and coatings for use in highly-corrosive environments, wherein the electrical conductivity of the resulting structure or coating is improved as a result of enhanced filler loading capacity of the composition.

It is another object of this invention to provide a composition, and a method for processing said composition, to form a thermally- and electrically-conductive polymer composite structure or coating for use in electronic, thermoelectric and electrochemical devices.

It is another object of this invention to provide a non-fluorinated composition for rapidly net shape molding a current collector plate for a polymer electrolyte membrane (PEM) fuel cell, wherein improved filler loading results in a current collector plate having a higher bulk electrical conductivity than conventional current collector plates fabricated from fluoropolymer-based compositions.

These and other objects of the invention are achieved with the novel compositions and methods of the present invention. Novel polymer compositions are provided for producing highly-conductive coatings and net shape molded structures for a variety of applications, including: corrosion-resistant electrical and thermal conductors and contacts; battery and capacitor electrodes; electrodes for electrochemical coating and synthesis of materials; and electrochemical device components, such as current collector plates for polymer electrolyte membrane (PEM) fuel cells.

Briefly, according to the invention, a highly-loaded polymer composition is provided for fabricating a structure or coating generally suitable for use in electronic, thermoelectric and electrochemical devices. In the preferred embodiment of the invention, the composition is particularly suited for compression molding and/or injection molding a current collector plate for a PEM fuel cell. The composition is comprised of a low viscosity polymer loaded with a chemically-inert, thermally and electrically conductive filler.

The polymer is chosen from the group of polymers having a melt viscosity of less than 1,000 Newton-seconds per square meter (N*s/m²) over a shear rate range of 1,000 to 10,000 sec⁻¹. Furthermore, it is preferred that the polymer has material properties and characteristics as summarized in Table 2 (below). Suitable families of polymers include: polyphenylene sulfide (PPS); modified polyphenylene oxide (PPO); liquid crystal polymer (LCP); polyamide; polyimide; polyester; phenolic; epoxy-containing resin and vinyl ester.

The polymer composition is loaded with highly-conductive filler. In the preferred embodiment of the invention, the filler comprises carbon and/or graphite particles having an average particle size ranging from approximately 0.1 to 200 microns, and preferably in the range of about 23 to 26 microns. The filler particles have a surface area ranging from approximately 1 to 100 m²/g, and preferably in the range of 7 to 10 m²/g (as measured by BET testing standards). The composition may include additional components, including: carbon and/or graphite nanofibers; carbon and/or graphite fibers; metal fibers such as stainless steel or nickel; and metal-coated carbon and/or graphite fiber concentrates having thermoplastic or thermoset sizing chosen from the aforementioned group of potential polymers.

The composition is subsequently formed into a desired shape by compression molding, injection molding, or a combination thereof. Alternatively, the composition can be used in cladding or coating operations.

### BRIEF DESCRIPTION OF THE DRAWINGS

There are shown in the drawings embodiments of the invention that are presently preferred, it being understood, however, that the invention is not limited to the precise arrangements and instrumentalities shown, wherein:

FIG. 1 is a graphical flowchart illustrating steps and preferred parameters for a preferred collector plate molding process according to the invention.

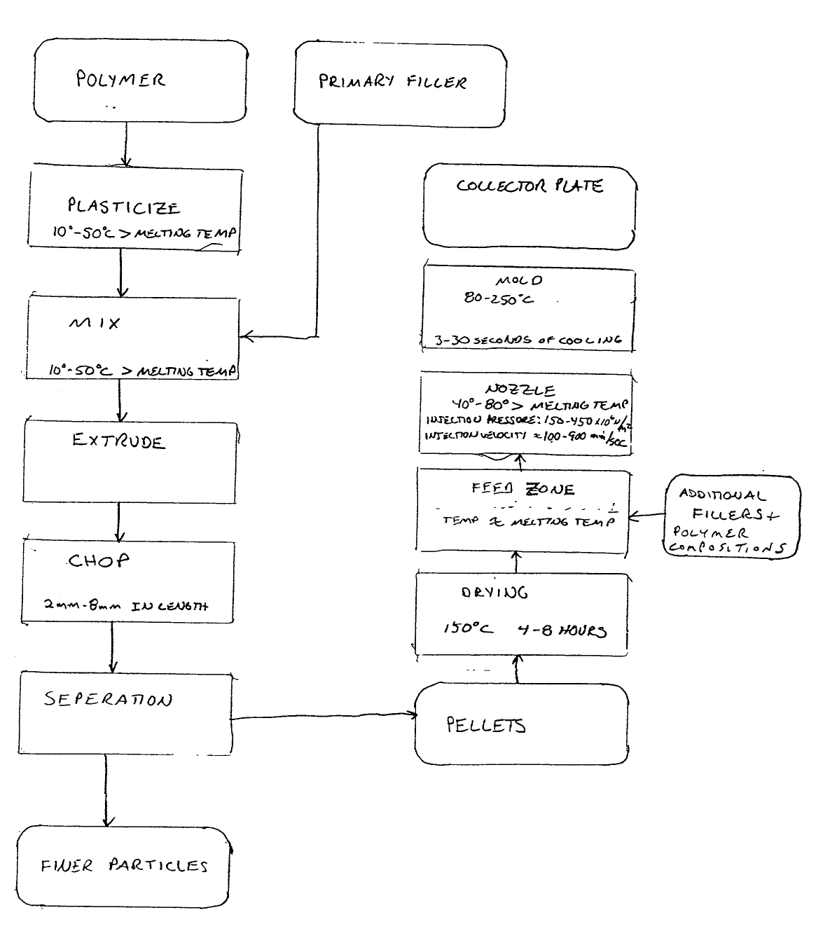

### DETAILED DESCRIPTION OF THE INVENTION

A novel composition is provided for fabricating a corrosion-resistant composite or surface coating having improved electrical conductivity. In the best mode of the invention, the composition is used to mold a unitary current collector plate for a polymer electrolyte membrane (PEM) fuel cell. However, the composition can be used to fabricate alternative collector plate structures as well. For instance, the composition can be coated onto the surface of a suitable substrate to form a multilayer collector plate structure. Accordingly, the term “structure” as used herein is intended to refer to either a unitary part or a coated part. Preferably, the composition comprises a low viscosity thermoplastic/thermoset resin combined with a highly-conductive carbon or graphite filler material.

The composition is chosen to produce a current collector plate capable of withstanding the harsh environment of a PEM fuel cell. Preferably, the composition is used to fabricate a current collector plate meeting particular criteria listed in Table 1 (below). In addition to having the properties and characteristics identified below, it is preferred that the collector plate is resistant to chemical and electrochemical degradation and hydrolysis, and has a bulk electrical resistance less than 50 mΩ-cm (or a bulk conductivity greater than 20 S/cm).

TABLE 1

| Property | Test Method | Value | Comments |
|---|---|---|---|
| Bulk Resistivity | 4-point probe | <50 mΩ-cm | |
| Bulk Density | | 1.5-2.25 | >2.25 (coated metals) |
| H₂ Permeability | | <5(10)⁻⁶ | 90° C.; 202(10³) N/m² |
| Thermal Index | UL746B | >45° C. | tensile strength |

Suitable binder resins are defined as non-fluorinated thermoplastic or thermoset polymers preferably having melt viscosities of less than 1,000 Newton-seconds per square meter (N*s/m²) over a shear rate range of 1,000 to 10,000 sec⁻¹, and additional material properties and characteristics defined in Table 2 (below). As used herein, the term “non-fluorinated” is intended to describe polymers other than fluoropolymers. Accordingly, nominal quantities of fluorine-containing components may be added to the present composition without changing the designation of the binder resin as a non-fluorinated polymer. For example, nominal quantities of Teflon® may be added to the binder resin to improve mold release characteristics of the final composition.

TABLE 2

| Property | Method | Value | Comments |
|---|---|---|---|
| Viscosity | Capillary | <1,000 N*s/m² | over a shear rate of |
| | Rheometry | | 1,000-10,000 sec⁻¹ |
| Thermal Index | UL746B | >45° C. | tensile strength |
| Hydrolytic | | >80% mechanical | 60° C. water; |
| Stability | | property retention | 1,000 hr |
| Particle Size | 60 mesh | >50% by wt. | <200 microns |
| | screen | | |
| T_{HEAT DEFLECTION} | ASTM D648 | >75° C. | at 1.82(10)⁶ N/m² |
| T_{MELTING} | | >90° C. | pref. 315-340° C. |
| Tensile Strength | ASTM D638 | 21-210(10)⁶ N/m² | pref. >40(10)⁶ |
| Density | | 1.0-2.0 g/cc | |
| Water | ASTM D570 | <10% wt gain | 23° C.; 24 hours |
| Absorption | | | |

Particular examples of polymer resins which meet these requirements include, but are not limited to, polyphenylene sulfide (PPS), low molecular weight PPS, liquid crystal polymer (LCP), and modified polyphenylene oxide. Suitable polyphenylene sulfides are commercially available from Phillips Chemical Company of Bartlesville, Okla., under the trade name Ryton®, and from Ticona Corporation of Summit, N.J., under the trade name Fortron®. Liquid crystal polymers having the desired properties are commercially available from Ticona under the trade name Vectra®, and from Amoco Performance Products, Inc. of Alpharetta, Ga., under the trade name Xydar®. A modified polyphenylene oxide having the desired properties is commercially available from General Electric Company of Pittsfield, Massachusetts, under the trade name Noryl®. Combinations of the above-identified polymer resins have the desired properties listed in Table 2.

Prior to being molded, the polymer resin is combined with highly conductive filler particles. Preferably, the filler particles comprise carbon and/or graphite and have properties and characteristics as defined below in Table 3.

TABLE 3

| Property | Method | Value | Comments |
|---|---|---|---|
| Carbon Content | — | >89% | ideal: >98% |
| Pressed Density | — | 1.8-2.0 g/cm³ | at 44.8(10)⁶ N/m² |
| Particle Size | 200 mesh | >70% by wt. | ideal: >98% by wt. |
| | screen | | |
| Average Particle | — | 0.1-200 μm | ideal: 23-26 μm |
| Size | | | |
| Surface Area | BET | 5-50 m²/g | Ideal: 7-10 m²/g |
| Electrical | — | <15 mΩ-cm | at 48(10)⁶ N/m² |
| Resistivity | | | |

The filler may be provided in various forms, including particles, fibers, flakes and spheres. However, it is preferred that the filler material comprises a high purity graphite powder having a carbon content of greater than 98 percent. The use of graphite is preferred because graphite is electrochemically stable in a wide range of environments. The use of a powder form is preferred because powders are less apt to impede the flow of the composition during molding. Preferably, the graphite powder has an average particle size of approximately 23-26 microns, and a BET-measured surface area of approximately 7-10 m²/g. The incorporation of small, low surface area conductive particles in the novel composition of the present invention is a significant departure from conventional conductive composites used to fabricate structures for electronic, thermoelectric and electrochemical devices. Conventional conductive composites, such as those used to fabricate fuel cell collector plates, typically contain conductive particles having a very high surface area combined with a small particle size. For instance, carbon black particles having a surface area of greater than 500 m²/g and a particle size of less than 1 micron are typical. Commonly, conventional conductive composites also contain large fibers having a low surface area. For instance, fibers having a surface area of less than 10 m²/g coupled with a fiber length in excess of 250 microns are typical.

The combination of reduced filler particle size and reduced filler particle surface area provides a means for maintaining material flow while increasing filler particle loading. Significantly, the relatively low particle size and surface area enable greatly improved filler particle packing densities as compared to known compositions for molding current collector plates. A corresponding increase in solids loading results in a fabricated plate having increased electrical conductivity, while minimizing gas permeable voids. Graphite powders having the above-identified properties are available from UCAR Carbon Company, Inc. of Lawrenceburg, Tenn., as well as from Asbury Carbons, Inc. of Asbury, N.J.

Carbon nanofibers may be added to the composition to improve electrical conductivity and mechanical strength of the molded collector plate. The carbon nanofibers typically have diameters ranging from a few nanometers to several hundred nanometers, and aspect ratios ranging from 50 to 1,500. Further additives may include carbon fibers, metal fibers such as stainless steel or nickel, and/or metal-coated carbon fiber concentrates having polymer sizing chosen from the aforementioned group of potential polymers (i.e., polyphenylene sulfides, modified polyphenylene oxides, liquid crystal polymers, polyamides, polyimides, polyesters, phenolics, epoxy-containing resins, epoxy novolacs and vinyl esters).

The preferred composition contains 45-95 wt % graphite powder, 5-50 wt % polymer resin, and 0-20 wt % metallic fiber, carbon fiber and/or carbon nanofiber. Preferably, the loading of the primary filler, for example graphite power, is greater than 65 wt %. In a most preferred embodiment of the invention the composition is 70-85 wt % graphite powder, GP195 from UCAR Carbon Company, Inc. of Lawrenceburg, Tenn., and 15-30 wt % LCP (Liquid Crystal Polymer), A95ORX from Ticona Corporation of Summit, N.J.. Where metallic fibers are added, it is preferred that at least 50 percent of the fibers have diameters ranging from a few nanometers to about 50 microns, and aspect ratios ranging from 10 to 5,000.

Additional filler can be added to the mixture, these additional filler can include conductive fibers or fiber concentrates, such as nickel coated carbon fibers pelletized in PPS or LCP resin. These may be blended with pellets of the preferred composition during, for example, the injection molding phase. Conductive fiber additives may also be introduced with the preferred composition during compounding.

The composition is formed into a composite having a desired geometry by various methods including compression molding, injection molding, or a combination thereof.

Compression Molding

In the case of compression molding, the graphite and polymer powders, and/or metal-coated carbon particles or fibers, are initially blended together to obtain a uniform distribution and composition. A preform of the mixed blend is created by compressing the blend using a pressure of 5-100×10⁶ N/m² at a temperature below the melting temperature of the polymer constituent, and preferably at room temperature. The preform is heated to a temperature greater than the polymer melting temperature for a period of approximately 1-45 minutes. Subsequently, the preform is placed between mold platens heated to a temperature in the range of 180-350° C. The mold platens are brought together at a clamping pressure of about 1-15(10)⁶ N/m² and trapped gas within the mold is removed by a degassing step in which a vacuum is applied. The degassing step takes approximately 1 minute. Following degassing, the mold clamping pressure is increased to about 5-75×10⁶ N/m². Subsequently, the mold is cooled to a temperature in the range of approximately 80-250° C., and the part is removed from the mold.

Compounding Prior to Injection Molding

According to the invention, the polymer and the primary fillers, for example graphite powder, are combined into pellets for later use during the molding process.

Although any method capable of forming the pellets is acceptable for use with the invention, the preferred method of forming the pellets includes mixing and heating of the polymer and primary fillers followed by an extrusion of the mixture.

In a most preferred embodiment of the invention, the primary fillers and polymer are fed into a heated extrusion barrel, which is heated to a temperature above the melting temperature of the polymer matrix.

Preferably, the temperature of the extrusion barrel is approximately 10° C. to 50° C. above the melting temperature of the polymer matrix. In a most preferred embodiment, the temperature of the barrel is about 300 C above the melting temperature of the polymer matrix.

The polymer and the primary filler material are preferably fed into the barrel in a manner that maintains an accurate mix ratio. Although any apparatus capable of feeding with an accurate mix ratio the polymer and primary filler into the barrel is acceptable for use with this invention, the presently preferred apparatus are loss in weight feeders.

Upon entering the extrusion barrel, the polymer is plasticized and the primary filler is dispersed into the polymer. The invention is not limited as to any apparatus capable of plasticizing the polymer and dispersing the primary filler. However, the presently preferred apparatus includes one or more screws within the barrel. In a most preferred embodiment, the primary filler is introduced into the polymers to be dispersed after the polymer has been substantially plasticized.

In a presently preferred embodiment, the total feed volume, which comprises the primary filler plus the polymer, is considerably less than the available volume of the barrel. In this manner, the barrel is starved, and starving the barrel allows for the material to be conveyed at a relatively uniform rate, such as 50% -80% capacity.

Upon plasticizing the polymer and mixing the primary filler into the polymer, the resulting highly viscous material is extruded under pressure, for example, 300-500 psi, through one or more die openings at the end of the barrel. Because the compound has a relatively high viscosity, the L/D ratio (land length divided by diameter) of the die openings is preferably less than 1.5. This avoids pressure buildup at the die openings and process instability. For a preferred diameter of 3 mm, the land length of the die should be 5 mm or less. In an alternative embodiment of the invention, the die face can be heated to avoid heat sinks that may cause solidification of the polymer phase.

Upon extruding the mixture, because the material loses heat quickly, it is not necessary to solidify the mixture by water cooling. The solidified extrudate is then preferably cut into pellets. Although any method of cutting the extrudate into pellets is acceptable for use in the invention, the extrudate is preferably chopped into pellets at the die face by rotating blades. The presently preferred speed of the rotary blade is adjusted to provide a pellet length of about 2 mm to 8 mm.

Once the pellets are formed, finer particles can be separated from the pellets. Although any apparatus so capable is acceptable for use with the invention, the pellets are preferably separated from the finer particles using a vibratory classifier or a fluidized bed. The compounded pellets are then generally dried to remove moisture by passing air at approximately 150° C. through the pellets for 4 to 8 hours.

Injection Molding

The pellets are used to supply an injection molding machine which injects the molten material into a mold. In a preferred embodiment of the invention, the pressure at which the molten material is injected into the mold is significantly higher than that traditionally used for injection molding of polymer compositions. This increased injection pressure provides for increased part packing, particularly in large, thin parts such as collector plates. Because of the higher molding pressure and increased part packing, a higher amount of the primary filler, typically a form of graphite or carbon with collector plates, significantly improves the density, electrical and thermal conductivity, mechanical strength and barrier properties of the composite.

Because of the higher injection pressure, a higher injection velocity is provided. This higher injection velocity reduces the polymer rich outer layer skin formation otherwise found in parts molded using a lower velocity. The outer skin that forms is an oriented layer that solidifies at the cavity surface as the melt front advances within the cavity of the mold.

For highly filled polymer compositions, the skin generally contains a higher density of polymer near the mold cavity surface compared to the bulk of the material. In general, as the injection velocity increases, the thickness of the skin decreases. Importantly, this skin formation becomes a frozen layer and can cause a flow restriction that limits the flow length and packing pressure. However, a higher injection velocity allows more pressure to be transmitted through the cavity and subjects the composite material to higher shear forces. As a result, a molded part having a denser concentration is achieved. Furthermore, it is found that when a conductor plate is formed according to the invention using the higher injection velocity, the plate conductivity is improved.

Although any method of obtain a higher injection pressure and velocity is acceptable for use in the invention, the presently preferred injection method is hereinafter described. The pellets as described above are introduced into the barrel of an injection molding machine. This barrel preferably contains a screw with a L/D (length/diameter) ratio at least 15 to 1, and the speed of the screw is maintained between 100 to 350 rpm. Also, the compression ratio within the screw is typically between 1.5 to 1 and 3.5 to 1.

The barrel preferably consists of zones that are separately heated and increase in temperature from the feed zone to the nozzle. For example, whereas the feed zone temperature is maintained approximately at the melting temperature of the polymer matrix, the nozzle temperature is maintained approximately 40° C. to 80° C. higher than the polymer melting temperature. Advantageously, the higher nozzle temperature reduces the drop in pressure as the molten material is injected through the nozzle. Additionally, the higher nozzle temperature allows for sufficient heat to be retained within the melt during the period of injection into the mold cavity. Furthermore, the mold temperature is maintained between about 80° C. to 250° C. to also allow for increased flow lengths.

In a preferred embodiment of the invention, the heated nozzle is extended to a presently preferred length of greater than 15 cm to introduce the heated polymer composition closer to the mold cavity. Also, the extended nozzle is used in combination with a sprue having a reduced height and a diameter greater than 5 mm to minimize pressure losses as the material travels toward the mold cavity.

The mold unit preferably reduces the resistance to flow by using large flow orifices. Also, the mold unit can have a center or edge gate where the polymer composition enters the mold cavity. Additionally, semi-circular and circular runners having diameters approximately 0.5 cm to 1.5 cm can be placed adjacent to part surfaces to increase the flow length. In contrast to typical molding practices, these runners can then be removed, for example by a cutting, grinding or similar operation, after the part has been removed from the mold. Such runners can advantageously reduce the injection and clamp pressure requirements when molding large thin plates such as fuel cell collector plates. These collector plates typically have dimensions of 23 cm×46 cm with a thickness of approximately 0.2 cm.

A hot manifold within the injection mold can also be used to deliver hot material to specific locations within the cavity. Hot manifold technology is well known in the art as a means for conveying material into a mold that would otherwise require a very long flow length for filling, and the invention is not limited as to a particular type of hot manifold. The advantage to hot manifold molding is the ability to fill cavities that would require flow length to wall thickness ratio significantly greater than 30.

In a preferred embodiment, the hot manifold contains multiple gates or valves that can be opened in a sequential manner. This sequential opening allows the flow front to be re-pressurized by the hot material. By way of example, the primary valve gate opens to allow the injection of material into the cavity. As the flow front progresses a certain distance, the flow front approaches a closed valve gate that is connected to the hot manifold. When the flow front passes this valve, the flow front triggers the valve to open, which exerts the melt pressure from the injection unit to accelerate the melt front in the cavity.

Advantageously, this compensates for the pressure lost in the mold cavity by the melt front traveling from the primary valve gate to the sequential valve gate. However, when compared with sprue, edge, or runner less gating, the addition of the hot manifold does not necessarily provide a more conductive molded composite without the addition of the higher high injection velocities as previously discussed.

In a preferred embodiment, when working with a highly filled composition, the injection unit forward time is kept less than about two seconds. Typically, the time required for part cooling with the mold closed is approximately 3 to 30 seconds. Although the cycle time between mold close and mold open may be between about 3 and 90 seconds, cycle time is preferably between about 10 and 30 seconds.

Although any method of increasing the injection pressure is acceptable for use with this invention, an accumulator is the presently preferred means of increasing the available injection pressure. State-of-the-art injection units with compressed gas accumulators, capable of achieving injection pressures in excess of 200×10⁶ N/m², are available from a number of machine manufacturers. Manufacturers of such equipment include Husky Injection Molding Systems, Ltd., of Bolton, ON, Canada and Nissei America, Inc., of Anaheim, Calif.

Although the available injection pressure is approximately 20-600×10⁶ N/m², the presently preferred injection pressure for use with the invention is between about 150-450×10⁶ N/m². Injection pressures considerably above 200×106 N/m² can be achieved with some modifications.

An example of such a modification includes down-sizing the injection screw unit to intensify the available pressure. Injection molding machines typically have a maximum hydraulic system pressure of about 20×10⁶ N/m². This pressure is applied by a piston positioned behind the injection screw unit. The pressure is then transferred along a rod to a check ring on the end of the screw.

An intensification of pressure occurs during injection, and this intensification is equivalent to the ratio of the cross sectional area of the hydraulic piston to the cross sectional area of the screw check ring. Generally, this ratio is approximately 10. However, by installing a smaller injection unit, this ratio can be increased to 20; which corresponds to an injection pressure of about 400×10⁶ N/m². As such, down-sizing the injection screw unit is an effective means of increasing the available injection pressure.

Depending on shot size, injection velocity and material composition, typical pressure losses through a standard 6.35 mm nozzle are about 35-70×10⁶ N/m². Also, depending on mold design, an equivalent amount of pressure may be lost through the runner and gate. For standard equipment designs, approximately 140×106 N/m² of pressure is lost before the material reaches the intended location in the mold.

The range of available machine injection pressure is only 140-200×10⁶ N/m² using an injection screw unit that is not modified for pressure intensification. As a result, the flow length is be significantly diminished, and part packing will only be developed in very small parts. Consequently, intensification of injection pressure allows for part packing during the molding of large thin parts, such as collector plates for PEM fuel cells.

Due to the use of increased injection and cavity pressure, the required clamp force to keep the mold closed during injection cannot be estimated by the traditional methods. Traditionally, the required force can be approximated by multiplying the area of the mold cavity (in meters) by a factor of 40×10⁶ N/m² to 70×10⁶ N/m², depending on the viscosity of the polymer or polymer composite.

As an example, a 15 cm×15 cm plaque has a projected area of 0.0225 m². For traditional compositions and molding conditions, the required force to keep the mold closed would be approximately 1.2×10⁶ N. However, the clamp force, using the method according to the present invention is significantly higher, can exceed 3.6×10⁶ N. This increase in clamp force results from a significant increase in cavity pressure in comparison to current injection molding methods.

High injection velocities are achieved with a pressure accumulator, when sufficient pressure is developed on both sides of the screw prior to the injection command. Rapid movement or “firing” of the screw is made possible when the pressure in front of the screw is released. Whereas traditional injection velocities are typically between about 10 to 100 mm/sec, the use of accumulator assist can increase the injection velocities to well above 1,000 mm/sec.

Optimum injection velocity depends on several factors which include barrel size and part geometry. Also, the velocity frequently varies during the injection cycle. The presently preferred range of injection velocities is about 100 to 900 mm/sec. An advantage of having a high injection velocity is quicker fill times, such that the material does not freeze off in the cavity before the part is filled. Also, higher velocities create higher shear forces that result in lower material viscosity.

When the above-identified process is used to produce collector plates for fuel cells, the resulting plates are highly conductive. In addition to being highly conductive, these plates must also be non-porous, resistant to long periods of hot water exposure, exhibit low cost, be manufacturable in high volumes, and have excellent dimensional tolerance control. According to a preferred embodiment of the invention, the final product is manufactured with high temperature, low viscosity thermoplastic polymers (for example LCP and/or PPS) and graphite powder. The product may also contain additives, for example, carbon fibers, graphite fibers, nickel coated carbon fibers or metal fibers, to enhance bulk conductivity. Such a product is superior to state-of-the-art compression molded thermoset polymer composites in that better dimensional control is achieved during molding, resistance to hot water is greatly improved, production cycle time is dramatically decreased, and the final product is recyclable.

In a some instances, it may be desirable to employ a combination injection/compression molding process wherein the injection molded structure is subjected to a compression step following molding. This final compression step may, for instance, be employed to further enhance the conductivity of the molded structure by increasing the conductive filler packing density.

In an alternate embodiment of the invention, the novel composition is melted and applied to a metallic surface to provide a hardened, highly conductive protective layer upon cooling. The composition provides a means for protecting an underlying metallic structure from corrosion, while precluding a significant increase in electrical resistance. Structures suitable for fuel cell applications (i.e., having properties listed in Table 1) can be formed using numerous different coating methods. For instance, a coated structure can be formed by coating thin, stamped or etched metal substrates with novel composition. Coating methods include cladding or hot roll coating a metal sheet, and subsequently hot stamping the coated surface to form a desired surface geometry.

While the preferred embodiments of the invention have been illustrated and described, it will be clear that the invention is not so limited. Numerous modifications, changes, variations, substitutions and equivalents will occur to those skilled in the art without departing from the spirit and scope of the present invention as described in the claims.

What is claimed is:

1. A process for making a highly conductive polymer composite part, comprising the steps of:
providing a mixture including a non-fluorinated polymer binder having a melt viscosity of less than 1,000 Newton-seconds per square meter (N*s/m²) over a shear rate range of 1,000 to 10,000 sec⁻¹; and
a plurality of electrically conductive particles fixed in said polymer binder, said composite having a bulk conductivity of at least approximately 10 S/cm;
heating said mixture to a temperature greater than the melting temperature of said polymer binder;
injecting said mixture into a mold cavity;
allowing said mixture to cool to a temperature below the melting temperature of said polymer binder to form a unitary part; and
removing said unitary part from said mold cavity.

2. The process of claim 1, wherein the step of providing a mixture includes: feeding the conductive filler and feeding the polymer binder into a heated extrusion barrel;
melting the polymer binder in the extrusion barrel;
extruding the mixture from the extrusion barrel;
making pellets from the extruded mixture; and
melting said pellets prior to injecting said mixture to said mold cavity.

3. The process of claim 2, wherein the extrusion barrel is heated between 10 degrees C and 50 degrees C above the melting temperature of the polymer binder.

4. The process of claim 2, wherein the polymer binder is first fed into the extrusion barrel and plasticized, then the conductive filler is dispersed into the polymer binder.

5. The process of claim 2, wherein a total feed volume of the polymer binder and the conductive filler is less than approximately 80% of the capacity volume of the extrusion barrel.

6. The process of claim 2, wherein the mixture is extruded through a die having a land to diameter ratio of 1.5 or less.

7. The process of claim 6, wherein the mixture is extruded through the die at pressure of at least 300 psi.

8. The process of claim 6, wherein the die face is heated.

9. The process of claim 2, wherein filler particles below a minimum size are removed from the pellets prior to melting.

10. The process of claim 9, wherein the particles are removed using one of a vibratory classifier and a fluidized bed.

11. The process of claim 1, wherein the mixture is injected into the mold cavity at a pressure of at least 150×10⁶ N/m².

12. The process of claim 11, wherein an injection unit is provided for injecting the mixture into the mold cavity, said injection unit having a piston for supplying pressure and a screw check ring, a ratio of the cross sectional area of the piston to the cross sectional area of the screw check ring is at least approximately 20.

13. The process of claim 11, wherein the mixture is injected into the mold cavity at a velocity of at least 100 mm/sec.

14. The process of claim 11, wherein the mixture is injected into the mold cavity at a velocity of at least 500 mm/sec.

15. The process of claim 1, wherein the mixture is injected into the mold cavity at a velocity of at least 100 mm/sec.

16. The process of claim 1, wherein the mixture is injected into the mold cavity at a velocity of at least 500 mm/sec.

17. The process of claim 1, wherein the mixture is provided in the form of pellets, said pellets are melted above the melting temperature of the polymer binder in a container having a nozzle feeding to the mold cavity.

18. The process of claim 17, wherein the container includes a screw having a length to diameter ratio of at least 15 to 1 and a screw speed of approximately between 100 and 350 rpm.

19. The process of claim 18, wherein the compression ratio within the screw is between approximately 1.5 and 3.5.

20. The process of claim 17, wherein the container is heated in at least two zones of different temperature, one zone at a first temperature proximate a feed entry for the pellets and a second zone at a second temperature higher than the first temperature proximate the nozzle.

21. The process of claim 11, wherein the temperature of the nozzle is approximately 40 to 80 degrees C higher than the melting temperature of the polymer binder.

22. The process of claim 11, wherein the nozzle has a length of at least 15 mm.

23. The process of claim 11, wherein a sprue is connected to the nozzle and has a diameter greater than 5 mm.

24. The process of claim 11, wherein runners having diameters of approximately between 0.5 cm and 1.5 cm are provided between the nozzle and mold cavity.

25. The process of claim 11, wherein the mixture is injected into the mold cavity through a hot manifold.

26. The process of claim 1, wherein the mixture is further compressed after cooling to form the part.

27. The process of claim 1, wherein the mixture is formed on a metallic substrate.

28. The process of claim 1, wherein said non-fluorinated polymer binder has a melt viscosity of less than 200 Newton-seconds per square meter (N*s/m²) over a shear rate range of 1,000 to 10,000 sec⁻¹.

29. A highly conductive polymer composite part made from a process comprising the following steps:
providing a mixture including a non-fluorinated polymer binder having a melt viscosity of less than 1,000 Newton-seconds per square meter (N*s/m²) over a shear rate range of 1,000 to 10,000 sec⁻¹; and
a plurality of electrically conductive particles fixed in said polymer binder, said composite having a bulk conductivity of at least approximately 10 S/cm;
heating said mixture to a temperature greater than the melting temperature of said polymer binder;
injecting said mixture into a mold cavity;
allowing said mixture to cool to a temperature below the melting temperature of said polymer binder to form a highly conductive polymer composite part; and
removing said part from said mold cavity.

30. A process for making a current collector plate for fuel cell, comprising the steps of:
providing a mixture including a conductive filler and a polymer binder;
heating said mixture to a temperature greater than the melting temperature of said polymer binder;
injecting said mixture into a mold cavity;
allowing said mixture to cool to a temperature below the melting temperature of said polymer binder to net shape mold a unitary collector plate having a series of grooves formed in planar surfaces of the collector plate; and
removing said unitary collector plate from said mold cavity.

31. The process of claim 30, wherein the step of providing a mixture includes: feeding the conductive filler and feeding the polymer binder into a heated extrusion barrel;
melting the polymer binder in the extrusion barrel;
extruding the mixture from the extrusion barrel;
making pellets from the extruded mixture; and
melting said pellets prior to injecting said mixture to said mold cavity.

32. The process of claim 31, wherein the polymer binder is first fed into the extrusion barrel and plasticized, then the conductive filler is dispersed into the polymer binder.

33. The process of claim 31, wherein a total feed volume of the polymer binder and the conductive filler is less than approximately 80% of the capacity volume of the extrusion barrel.

34. The process of claim 31, wherein the mixture is extruded through a die having a land to diameter ratio of 1.5 or less.

35. The process of claim 33, wherein the mixture is extruded through the die at pressure of at least 300 psi.

36. The process of claim 33, wherein the die face is heated.

37. The process of claim 31, wherein filler particles below a minimum size are removed from the pellets prior to melting.

38. The process of claim 36, wherein the particles are removed using one of a vibratory classifier and a fluidized bed.

39. The process of claim 1, wherein the mixture is injected into the mold cavity at a pressure of at least 150×10⁶ N/m².

40. The process of claim 38, wherein an injection unit is provided for injecting the mixture into the mold cavity, said injection unit having a piston for supplying pressure and a screw check ring, a ratio of the cross sectional area of the piston to the cross sectional area of the screw check ring is at least approximately 20.

41. The process of claim 38, wherein the mixture is injected into the mold cavity at a velocity of at least 100 mm/sec.

42. The process of claim 38, wherein the mixture is injected into the mold cavity at a velocity of at least 500 mm/sec.

43. The process of claim 30, wherein the mixture is injected into the mold cavity at a velocity of at least 100 mm/sec.

44. The process of claim 30, wherein the mixture is injected into the mold cavity at a velocity of at least 500 mm/sec.

45. The process of claim 30, wherein the mixture is provided in the form of pellets, said pellets are melted above the melting temperature of the polymer binder in a container having a nozzle feeding to the mold cavity.

46. The process of claim 44, wherein the container includes a screw having a length to diameter ratio of at least 15 to 1 and a screw speed of approximately between 100 and 350 rpm.

47. The process of claim 45, wherein the compression ratio within the screw is between approximately 1.5 and 3.5.

48. The process of claim 44, wherein the container is heated in at least two zones of different temperature, one zone at a first temperature proximate a feed entry for the pellets and a second zone at a second temperature higher than the first temperature proximate the nozzle.

49. The process of claim 38, wherein the temperature of the nozzle is approximately 40 to 80 degrees C higher than the melting temperature of the polymer binder.

50. The process of claim 38, wherein the nozzle has a length of at least 15 mm.

51. The process of claim 38, wherein a sprue is connected to the nozzle and has a diameter greater than 5 mm.

52. The process of claim 38, wherein runners having diameters of approximately between 0.5 cm and 1.5 cm are provided between the nozzle and mold cavity.

53. The process of claim 38, wherein the mixture is injected into the mold cavity through a hot manifold.

54. The process of claim 38, wherein the mixture is further compressed after cooling to form the part.

55. The process of claim 30, wherein the mixture is formed on a metallic substrate.

56. A collector plate made from a process comprising the following steps:
providing a mixture including a conductive filler and a polymer binder;
heating said mixture to a temperature greater than the melting temperature of said polymer binder;
injecting said mixture into a mold cavity;
allowing said mixture to cool to a temperature below the melting temperature of said polymer binder to net shape mold a unitary collector plate having a series of grooves formed in planar surfaces of the collector plate; and
removing said unitary collector plate from said mold cavity.
